(19) United States
(12) Patent Application Publication
(10) Pub. No.: US 2019/0202234 A1
(43) Pub. Date: Jul. 4, 2019

(54) SHOCK ABSORBING CASTER SYSTEM AND METHOD

(71) Applicants: Christopher Woody, Orange, CA (US); Sean Schlueter, Gilbert, AZ (US)

(72) Inventors: Christopher Woody, Orange, CA (US); Sean Schlueter, Gilbert, AZ (US)

(21) Appl. No.: 15/861,500

(22) Filed: Jan. 3, 2018

(51) Int. Cl. B60B 33/04; B60B 33/00; A45C 5/14

(52) U.S. Cl. CPC B60B 33/045; B60B 33/0063; B60B 2900/131; A45C 5/14; A45C 2005/148; B60B 33/0028

(57) ABSTRACT

A shock absorbing caster system includes an inner-bearing, a flexible-hub, and outer-rim, and a cylindrical disc. The inner-bearing is configured as a roller-bearing and fixed to the flexible-hub. The inner-bearing is further surrounded by the outer-rim. The inner-bearing is fixed to the flexible-hub and to the outer-rim by a bonding process. The cylindrical disc is configured as a tire and further circumferentially affixed to the other-rim. The shock absorbing caster is useful for providing a caster wheel having a flexible hub with shock absorbing properties for use with luggage and other suitable applications.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of wheels of existing art and more specifically relates to luggage casters.

### Related Art

A caster (also castor) is a wheeled device typically mounted to a larger object that enables relatively easy rolling movement of the object. Casters are essentially special housings that include a wheel, facilitating the installation of wheels on objects. Casters are found virtually everywhere, from office desk chairs to shipyards, and from hospital beds to automotive factories. They range in size from the very small furniture casters to massive industrial casters, and individual load capacities span 100 pounds (45 kg) or less to 100,000 pounds (45 t). Wheel materials include cast iron, plastic, rubber, polyurethane, forged steel, stainless steel, aluminum, and more.

In the last several years, wheeled luggage has become commonly available and popular in the marketplace. Wheeled luggage commonly comprises two wheel assemblies attached to a bottom edge panel of the bag and a retractable handle assembly that extends up from the top edge panel of the bag. The wheels are relatively unobtrusive, allowing the bag to be carried like a conventional suitcase with the handle assembly retracted when desired. When the bag is transported with the assistance of the wheels, the handle assembly is extended out and the bag is tipped slightly forward and pulled along with a forward face panel in front.

While some wheeled luggage items are only used sparingly by their owners, other owners travel frequently, thereby making their luggage items indispensible to their livelihoods. As a result of these frequent travels, many luggage items experience premature breakdown, especially in the wheels. A suitable solution is desired.

U.S. Pat. No. 8,850,658 to Patrick Dayt, et al. relates to a shock-absorbing castor. The described shock-absorbing castor includes a casing constituted by a part having at least one housing suitable for receiving a pivot defined on an axis, and a bearing defined on an axis perpendicular to the axis, at least one wheel suitable for running on a surface, a shaft mounted to co-operate in the bearing, the wheel being mounted in association with the shaft, the part being constituted by at least two portions and that are made respectively of two materials of different flexibilities, the portion presenting the greater flexibility being interposed between the housing and the axial orifice of the bearing so as to isolate the housing and the bearing from each other. The castors may be used with furniture or the like, in particular in a hospital setting, e.g. for beds, tables, walkers, and also for moving suitcases, baggage, or the like.

### SUMMARY OF THE INVENTION

In view of the foregoing disadvantages inherent in the known wheels art, the present disclosure provides a novel shock absorbing caster system and method. The general purpose of the present disclosure, which will be described subsequently in greater detail, is to provide a caster wheel having a flexible hub with shock absorbing properties for use with luggage and other suitable applications.

A shock absorbing caster system is disclosed herein. The shock absorbing caster system may include an inner-bearing, a flexible-hub, and outer-rim, and a cylindrical disc. The inner-bearing may be configured as a roller-bearing, which may be fixed to the flexible-hub and further surrounded by the outer-rim. The inner-bearing may be fixed to the flexible-hub and to the outer-rim by a bonding process. The cylindrical disc may be configured as a tire and may further be circumferentially affixed to the other-rim.

According to another embodiment, a method of manufacturing a shock absorbing caster system is also disclosed herein. The method of manufacturing a shock absorbing caster system may include bonding a flexible-hub between an inner-bearing and an outer-rim to form a wheel-assembly when combined with a tire and mounting said wheel-assembly to a luggage-piece.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a shock absorbing caster system, constructed and operative according to the teachings of the present disclosure.

FIG. 1 is a perspective view of the shock absorbing caster system showing a shock absorbing caster affixed to a luggage item during an ‘in-use’ condition, according to an embodiment of the disclosure.

FIG. 2 is a perspective view of the shock absorbing caster system of FIG. 1 showing a free-standing shock absorbing caster, according to an embodiment of the present disclosure.

FIG. 3 is a front view of the shock absorbing caster system of FIG. 1 showing a free-standing shock absorbing caster including an inner-bearing, flexible-hub, outer-rim, and cylindrical disc, according to an embodiment of the present disclosure.

FIG. 4 is a side view of the shock absorbing caster system of FIG. 1, according to an embodiment of the present disclosure.

FIG. 5 is a flow diagram illustrating a method of manufacturing a shock absorbing caster system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to wheels and more particularly to a shock absorbing caster system as used to improve the durability of luggage caster wheels through enhanced shock absorbing configurations.

Generally, the shock absorbing caster system includes a caster wheel that may be suited for use on a luggage item or other portable device. The shock absorbing caster system features a flexible-hub wherein the flexible-hub is deformable in such a manner that a load is transferrable between a host-object and a substantially planar surface, such as a ground surface. By including this flexible-hub near the inner-bearing of the caster assembly, the entire assembly may bear repeated shocks or blunt forces that often lead to premature wear in other configurations.

Each shock absorbing caster wheel may be configured in many differing shapes and sizes. For example, the flexible-hub may feature an hourglass or I-beam design including lateral thru holes for increased stability or a reduced weight profile.

The outer-rim may be constructed as a single unit or feature a 2-piece assembly. The outer-rim may further be solid in configuration and constructed in a plurality of cross-sectional shapes. The cross-sectional configurations of the outer-rim may again feature lateral holes.

The shock absorbing caster may also include an inner-bearing at its core. The inner-bearing may be configured as a roller-bearing constructed from metal or plastic pieces. The inner-bearing may be fixed to the flexible-hub and to the outer-rim via a bonding process. This bonding may be achieved in a variety of ways, including a chemical, heat, or mechanical means, depending on the needs of the user. The inner-bearing may also include an integrated axle with a thru hole to accept said axle. Alternate embodiments may also feature an inner-bearing configured as a solid construction for an axle to be drilled therethrough.

Many embodiments of the shock absorbing caster may include a cylindrical disc circumferentially affixed to the outer-rim and further configured as a tire. This tire may be fixed, removable, inflatable, or solid depending on applications. The tire may further be constructed from rubber, plastics, or other composites suitable for wear in open environments. The precise configuration of the individual's casters and tires making up the shock absorbing caster system may also vary depending on applications. Some caster assemblies of this system may include a single wheeled configuration, while other assemblies may include two or more casters affixed to a vertical mount or other hub. The mounts and hubs used in this system may also be configured in many different ways to allow for rotating axles or fixed rail designs. Upon reading this specification, it should be appreciated that, under appropriate circumstances, considering such issues as user preferences, design preference, structural requirements, marketing preferences, cost, available materials, technological advances, etc., other caster wheel arrangements such as, for example, dual-hub configurations, etc., may be sufficient.

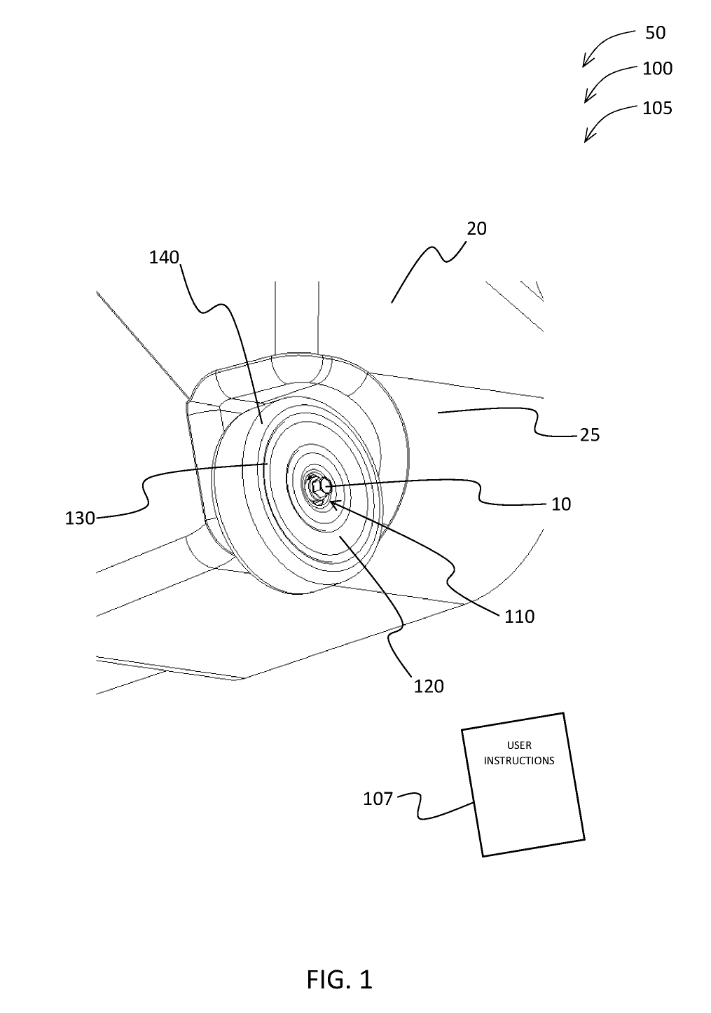

Referring now more specifically to the drawings by numerals of reference, there is shown in FIGS. 1-4, various views of a shock absorbing caster system 100.

FIG. 1 shows a shock absorbing caster system 100 during an ‘in-use’ condition 50, according to an embodiment of the present disclosure. Here, the shock absorbing caster system 100 may be beneficial for use by a user to provide a caster wheel having a flexible hub with shock absorbing properties for use with luggage and other suitable applications. As illustrated, the shock absorbing caster system 100 may include an inner-bearing 110 configured to fit around a luggage-axle 10, a flexible-hub 120 configured to absorb shock from bumps or other impacts, an outer-rim 130, and a cylindrical disc 140. The shock absorbing caster system 100 may be configured for use with a host-object 20 which may comprise a luggage-piece 25. The included flexible-hub 120 may be deformable such that a load can be transferrable between the host-object 20 and a substantially planar surface.

According to one embodiment, the shock absorbing caster system 100 may be arranged as a kit 105. In particular, the shock absorbing caster system 100 may further include a set of instructions 107. The instructions 107 may detail functional relationships in relation to the structure of the shock absorbing caster system 100 such that the shock absorbing caster system 100 can be used, maintained, or the like, in a preferred manner.

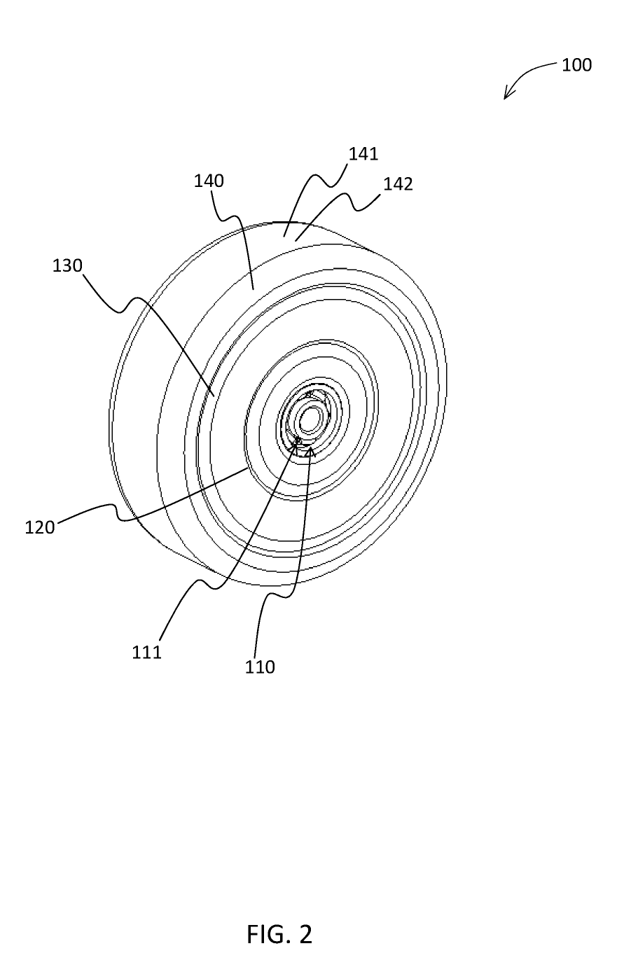

FIG. 2 shows the shock absorbing caster system 100 of FIG. 1, according to an embodiment of the present disclosure. As above, the shock absorbing caster system 100 may include an inner-bearing 110, a flexible-hub 120 configured to absorb shock from bumps or other impacts, an outer-rim 130, and a cylindrical disc 140. The inner-bearing 110 may comprise a roller-bearing 111. The cylindrical disc 140 may comprise a tire 141, or more specifically, a luggage-tire 142, which may be circumferentially affixed to the outer-rim 130.

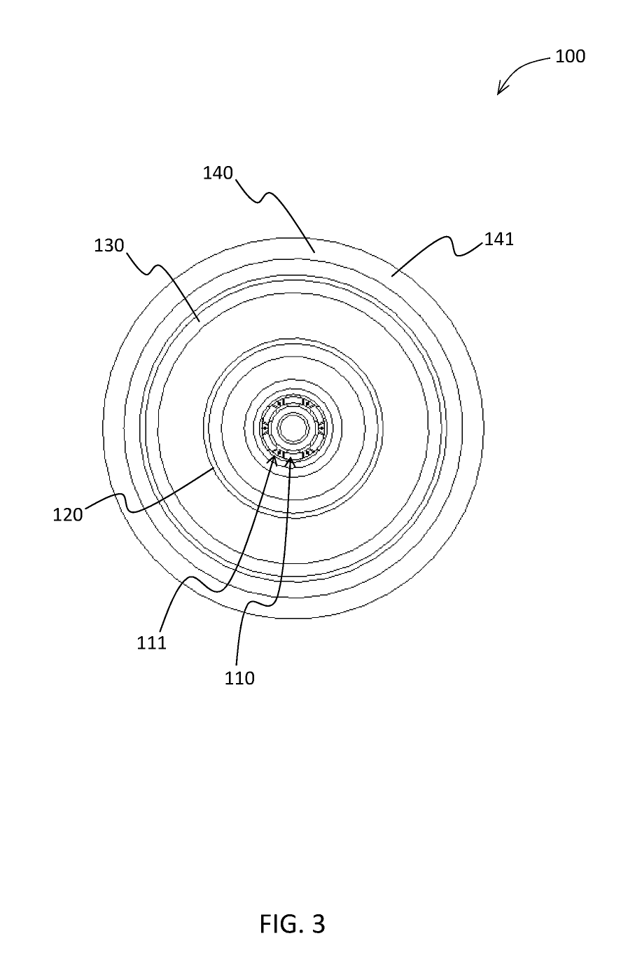

Referring now to FIG. 3 showing a front view of the shock absorbing caster system 100 of FIG. 1, according to an embodiment of the present disclosure. Here again, the shock absorbing caster system 100 may include an inner-bearing 110 comprising a roller-bearing 111, a flexible-hub 120 configured to absorb shock from bumps or other impacts, an outer-rim 130, and a cylindrical disc 140. The cylindrical disc 140 may comprise a tire 141 configured made from a plastic or rubber material to provide traction with a ground surface.

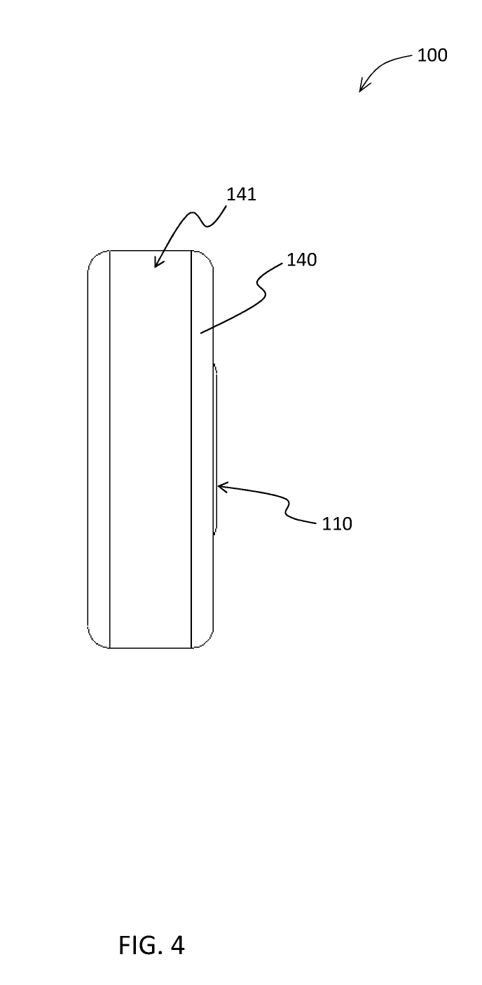

FIG. 4 is a side view of the shock absorbing caster system 100 of FIG. 1, according to an embodiment of the present disclosure. This side view illustrates a possible embodiment of the shock absorbing caster system 100. In this embodiment, the shock absorbing caster system 100 may include a cylindrical disc 140 comprising a tire 141, which is circumferentially affixed to the outer-rim 130 (see FIG. 1). The included inner-bearing 110 may project outwardly from the sides of the cylindrical disc 140 for further stability and union with the luggage-axle 10 (see FIG. 1) of the host-object 20 (see FIG. 1).

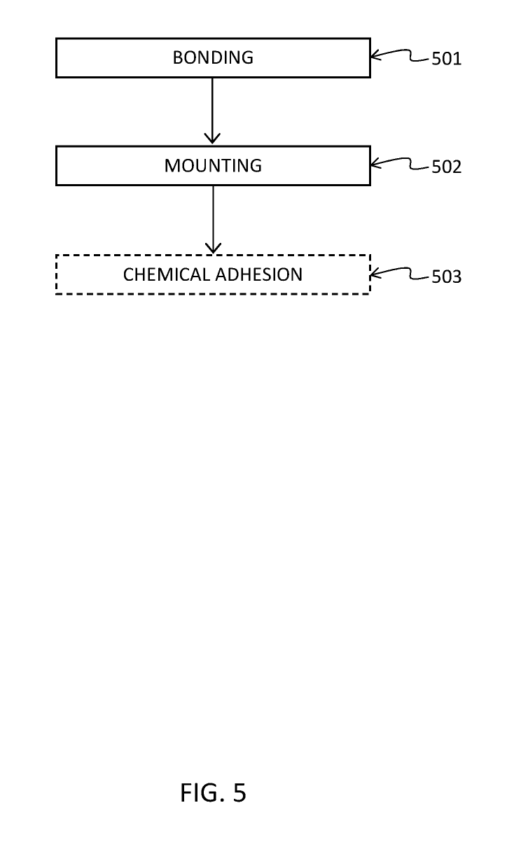

Referring now to FIG. 5, a flow diagram illustrating a method of manufacturing 500 a shock absorbing caster system 100, according to an embodiment of the present disclosure. In particular, the method of manufacturing 500 a shock absorbing caster system 100 may include one or more components or features of the shock absorbing caster system 100 as described above. As illustrated, the method of manufacturing 500 a shock absorbing caster system 100 may include the steps of: step one 501, bonding a flexible-hub 120 between an inner-bearing 110 and an outer-rim 130 to form a wheel-assembly when combined with a tire 141; and step two 502, mounting said wheel-assembly to a luggage-piece.

It should be noted that step three 503 is an optional step and may not be implemented in all cases. Optional steps of method of manufacturing 500 a shock absorbing caster system 100 are illustrated using dotted lines in FIG. 5 so as to distinguish them from the other steps of method of manufacturing 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for shock absorbing caster system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A shock absorbing caster system, the system comprising:
an inner-bearing;
a flexible-hub;
an outer-rim; and
a cylindrical disc;
wherein said inner-bearing is fixed to said flexible-hub and to said outer-rim;
wherein said flexible-hub is surrounded by said outer-rim;
wherein said cylindrical disc is circumferentially affixed to said outer-rim; and
wherein said flexible-hub is deformable such that load is transferrable between a host-object and a substantially planar surface.

2. The shock absorbing caster system of claim 1, wherein said cylindrical disc comprises a tire.

3. The shock absorbing caster system of claim 2, wherein said tire comprises a luggage-tire.

4. The shock absorbing caster system of claim 1, wherein said inner-bearing is fixed to said flexible-hub and to said outer-rim via a bonding process.

5. The shock absorbing caster system of claim 1, wherein said flexible-hub comprises rubber.

6. The shock absorbing caster system of claim 1, wherein said flexible-hub comprises plastic.

7. The shock absorbing caster system of claim 1, wherein said host-object comprises a luggage-piece.

8. The shock absorbing caster system of claim 1, wherein said inner-bearing fits around a luggage-axle.

9. The shock absorbing caster system of claim 7, wherein said luggage-piece is soft.

10. The shock absorbing caster system of claim 7, wherein said luggage-piece is rigid.

11. The shock absorbing caster system of claim 1, wherein said host-object is manually-operated.

12. The shock absorbing caster system of claim 1, wherein said host-object is non-manually-operated.

13. The shock absorbing caster system of claim 1, wherein said inner-bearing comprises a bushing.

14. The shock absorbing caster system of claim 1, wherein said inner-bearing comprises a roller-bearing.

15. The shock absorbing caster system of claim 3, wherein said luggage-tire comprises treads.

16. The shock absorbing caster system of claim 1, wherein said load is transferrable vertically between said host-object and said substantially planar surface, said substantially planar surface being a ground surface.

17. A shock absorbing caster system, the system comprising:
an inner-bearing;
a flexible-hub;
an outer-rim; and
a cylindrical disc;
wherein said inner-bearing is fixed to said flexible-hub and to said outer-rim;
wherein said inner-bearing comprises a roller-bearing;
wherein said flexible-hub is surrounded by said outer-rim;
wherein said cylindrical disc is circumferentially affixed to said outer-rim;
wherein said cylindrical disc comprises a tire;
wherein said tire comprises a luggage-tire;
wherein said inner-bearing is fixed to said flexible-hub and to said outer-rim via a bonding process;
wherein said flexible-hub comprises rubber;
wherein said inner-bearing fits around a luggage-axle; and
wherein said flexible-hub is deformable such that load is transferrable between a host-object and a substantially planar surface;
wherein said host-object comprises a luggage-piece; and
wherein said luggage-piece is rigid.

18. A method of manufacturing a shock absorbing caster system, the method comprising the steps of:
bonding a flexible-hub between an inner-bearing and an outer-rim to form a wheel-assembly when combined with a tire; and
mounting said wheel-assembly to a luggage-piece.

19. The method of claim 19, wherein said bonding comprises chemical adhesion.
